(19) United States
(12) Patent Application Publication
(10) Pub. No.: US 2022/0278646 A1
(43) Pub. Date: Sep. 1, 2022

(54) SYSTEM AND METHOD FOR CLEANING OF FLOATING SOLAR PANELS

(71) Applicant: Joe Joe Satyaraj Chellakat, Kochi (IN)

(72) Inventor: Joe Joe Satyaraj Chellakat, Kochi (IN)

(21) Appl. No.: 17/748,303

(22) Filed: May 19, 2022

(30) Foreign Application Priority Data
Jan. 12, 2022 (IN) 202241001893

(51) Int. Cl. H02S 40/10; B08B 3/02; B08B 3/14; B08B 13/00; C02F 1/00

(52) U.S. Cl. CPC H02S 40/10; B08B 3/02; B08B 3/14; B08B 13/00; C02F 1/001; C02F 1/008; B08B 2203/027; C02F 2201/009

(57) ABSTRACT

A system (100) and method for cleaning one or more main solar panels (9) installed on structures floating on a surface of a water body (11) disclosed. The system (100) has a plurality of cleaning units (12) installed on one or more main solar panels (9). Each of the cleaning unit (12) has a water pump (1) capable of uplifting water from the water body (11) thorough a water filter and deliver it to a discharge pipe (3). A flexible water intake pipe (2) installed as a conduit to lift water from the water body (11) to the water pump (1) installed on a control unit (5). The mini solar panel (4) installed on the cleaning unit (12) is used for generating electrical energy for powering the water pump (1), wherein the control unit (5) is used to control the functioning of the water pump (1).

### TECHNICAL FIELD

The present disclosure relates generally to a system and method for cleaning of floating solar panels which are installed on structures floating over water surface. Embodiments of the disclosure are related to cleaning of the solar panels that ensures efficient veneration of electrical power from solar panels.

### BACKGROUND

Floating Photovoltaic (FPV), solar panel are generally installed on a buoyant structure to keep them above the surface of water and are usually located on bodies of water such as ponds, other man-made reservoirs, lakes and oceans.

Floating solar arrays consists of multiple floating buoys or rectangular floating bodies joined together to loin a large floating array. Multiple solar panels are installed on top of these floating bodies.

Individual solar panels are generally covered with opaque material. Metallic frame ware provided on the edges of the panels. Lugs installed on this frame are used for connecting the panel to the floating structure that floats on the surface of water body.

These floating panels are exposed to external environment including dust, sand and other particles, including bird droppings.

Accumulation of dust and other particle on the solar panel reduces the efficiency of the panel to produce electrical power. It is, therefore, essential to keep the surface of the solar panels clean at all times.

Various methods are presently used for cleaning the solar panels. Almost all of them involves manual cleaning process when human intervention is involved.

Usually cleaning personnel has to first travel in a boat or dinghy to reach the floating solar array. Thereafter they have to carry the cleaning equipment on the delicate walkway of the floating structure to perform the cleaning operation of the solar panels. There exists safety hazard while walking over narrow flexible floaters and while extending themselves to reach the far away panels.

Typical solar cleaning equipment have elaborate piping systems it supplying the cleaning water and multiple water storage tanks.

A need, therefore, exists for an improved system and method for cleaning of the floating solar panels.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

In a first aspect of the present disclosure, a system for cleaning one or more main solar panels installed on structures floating on a surface of a water body, the system characterized in that comprising: a plurality of cleaning units installed on one or more main solar panels, wherein each of the cleaning unit comprises: at least one water pump capable of uplifting water from the water body and deliver it to a discharge pipe; at least one flexible water intake pipe installed as a conduit to lift water from the water body to the water pump installed on a control unit, wherein the flexible water intake pipe is installed along with a filter unit; at least one mini solar panel installed on the cleaning unit is used for generating electrical energy for powering the water pump; wherein the control unit is used to control the functioning of the water pump; at least one mechanical holding system to attach the cleaning unit on to the main solar panel; at least one water filter in the water intake pipe to remove any particles present in the water sucked through the water intake pipe.

According to an embodiment in conjunction to the first aspect of the present disclosure, the water used for cleaning of the main solar panels is obtained from the water body.

According to an embodiment in conjunction to the first aspect of the present disclosure the solar energy generated from a mini solar panel is used to power the cleaning unit.

According to an embodiment in conjunction to the first aspect of the present disclosure, each of the cleaning unit installed on the main solar panels are independent of each other.

According to an embodiment in conjunction to the first aspect of the present disclosure, each of the individual cleaning units are operated separately, removed or replaced without effecting the function of cleaning unit installed on adjacent solar panels.

According to an embodiment in conjunction to the first aspect of the present disclosure, the control unit is operated as a timer-based function or operated using an automatic control or an electronic wireless network control.

According to an embodiment in conjunction to the first aspect of the present disclosure, each of the individual cleaning units are configured to be installed on the main solar panels of various dimensions.

In a second aspect of the present disclosure, a method cleaning the main solar panels installed on structures floating on the surface of the water body, the method characterized in that comprising: installing the plurality of cleaning units on the main solar panels, uplifting, by the one water pump, the water from the water body; installing a discharge pipe on top of the main solar panels to be cleaned; delivering, by the water pump, the water to the discharge pipe; using the flexible water intake pipe as the conduit to lilt water from the water body to the water pump; installing the mini solar panel on the cleaning unit for generate electrical energy for powering the water pump; controlling, by the control unit, the functioning of the water pump; attaching, by the mechanical holding system, to attach the cleaning unit on to the solar panel; removing, by the water filter in the water intake pipe, any particles present in the water sucked through the water intake pipe.

According to an embodiment in conjunction to the second aspect of the present disclosure, the control unit is operated as a timer-based function or operated using an automatic control or an electronic wireless network control.

### BRIEF DESCRIPTION OF THE DRAWINGS

FIG. 1 is a perspective view of an example system for cleaning one or more main solar panels installed on structures floating on a surface of a water body, in accordance with the disclosed embodiment of the invention.

FIG. 2 is a side view of the system of FIG. 1, in accordance with the disclosed embodiment of the invention,

FIG. 3 is a top view of the system of FIG. 1, in accordance with the disclosed embodiment of the invention.

FIG. 4 is a perspective view of an example of various components of the cleaning unit of FIG. 1, in accordance with the disclosed embodiment of the invention.

FIG. 5 shows an example flowchart pertaining to an example method for cleaning one or more main solar panels installed on structures floating on a surface of a water body, in accordance with the disclosed embodiment of the invention.

The summary above, as well as the following detailed description of illustrative embodiments, is better understood when read in conjunction with the appended drawings. For the impose of illustrating the present disclosure, exemplary constructions of the disclosure are shown in the drawings. However, the disclosure is not limited to specific methods and instrumentalities disclosed herein. Moreover, those in the an will understand that the drawings are not to scale. Wherever possible, like elements have been indicated by identical numbers.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

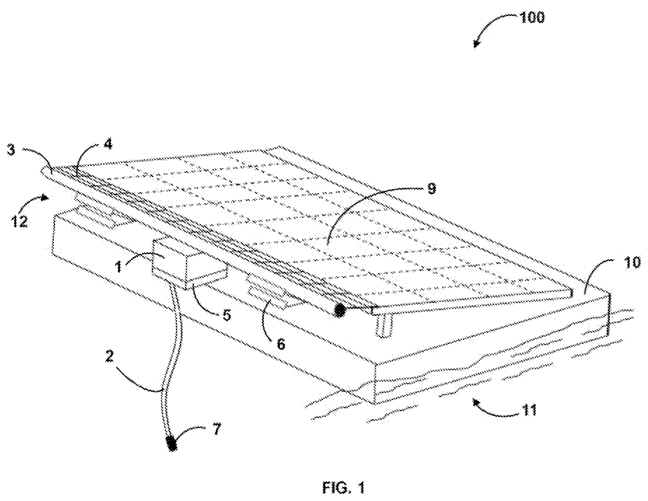

FIG. 1 is a perspective view of a system 100 for cleaning cone or more main solar panels 9 in on structures floating on a surface of a water body 11.

The system 100 has a plurality of cleaning units 12 installed on one or more main solar panels 9. Each of the cleaning unit 12 comprises at least one water pump 1 capable of uplifting water from the water body 11 and deliver it to a discharge pipe 3. At least one flexible water intake pipe 2 is installed as a conduit to lift water from the water body H to the water pump 1 installed on a control unit 5. The flexible water intake pipe 2 is installed along with a filter unit 7 to remove any particles present in the water sucked through the water intake pipe 2. At least one mini solar panel 4 is installed on the cleaning unit 12 for generating electrical energy for powering the water pump 1. The control unit 5 can be used to control the functioning of the water pump 1. At least one mechanical holding system 6 is used to attach the cleaning unit 12 to the main solar pawl 9.

In system 100 the water used for cleaning of main solar panel 9 is obtained from the water resources on which the floating solar plants are installed. Hence no additional piping and external water resources for cleaning the panels are utilized.

The solar energy generated from a mini solar panel 4 is used to power the cleaning unit 12. Hence, no external power source is required to power the proposed cleaning unit 12. The cleaning unit 12 generates required power from the mini solar panel 4 installed on itself. Each of the cleaning unit 12 installed on the main solar panels 12 are independent of each other and can be operated separately, removed or replaced without effecting the function of cleaning system installed on adjacent solar panels. Further, each of the individual cleaning units 12 can be configured to be installed on solar panels 9 of various dimension solar panel.

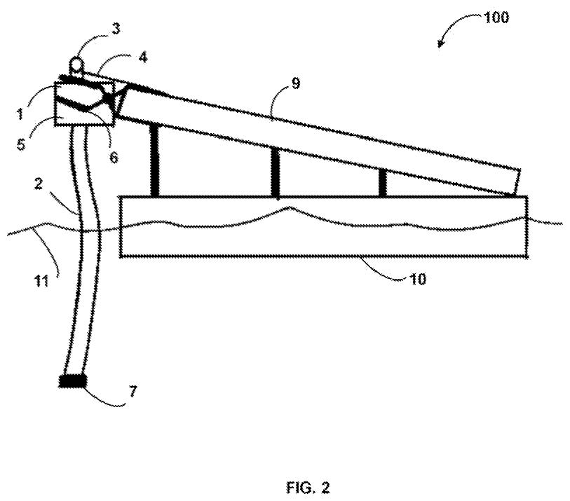

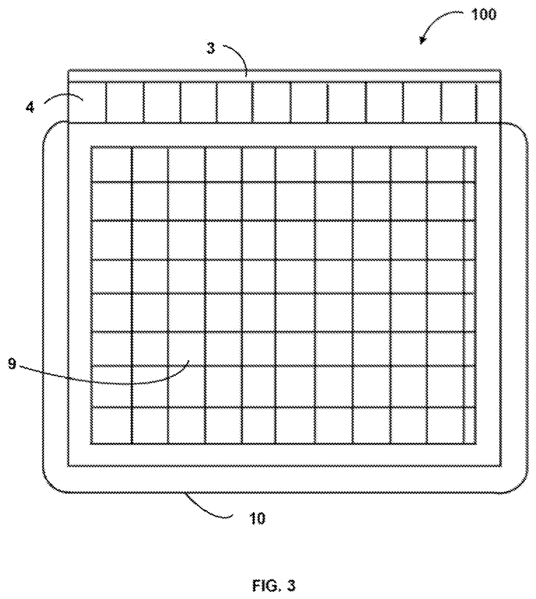

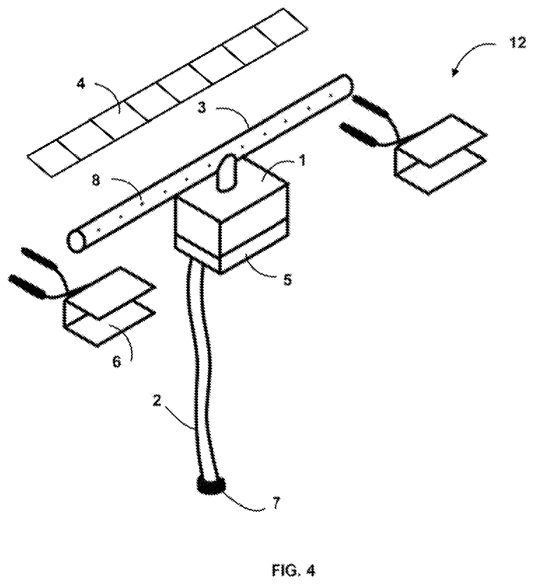

FIG. 2 is a side view of the system of FIG. 1 and FIG. 3 is a top view of the system of FIG. 1. FIG. 4 is a perspective view of an example of the solar panel cleaning unit 12 which can be easily installed on the floating solar panel, in accordance with the disclosed embodiment of the invention. The solar panel cleaning unit 12 cons is of the water pump 1, the flexible water intake pipe 2, the discharge pipe 3, the mini solar panel 4, the control unit 5 and the mechanical holding system 6, the water filter in the water intake pipe 7, a discharge slit 8 (shown in FIG. 4). The solar panel cleaning unit 12 is installed on the solar panel 9. The solar panels 9 are installed on the floater 10 which floats on the water body 11. The water pump 1 shall be capable of uplifting water from the water body 11 and deliver it to the discharge pipe 3. The water pump 1 shall be capable of working with the electric power generated from the mini solar panel 4 installed on the caning unit 12.

Flexible water intake pipe 2 is installed as a conduit to lift water from the water body 11 to the water pump 1 installed on the cleaning unit 12. Discharge pipe 3 is installed on top of the cleaning unit 12. Water discharged from the water pump 1 is discharged on the main solar panel 9 through the discharge slits 8 present on the discharge pipe 3. Size of the discharge pipe 3 is selected such that flow rate and the pressure of discharge is compatible with the power of the water pump 1. Length of the discharge pipe shall extend close to the full length of the solar panel 9 on which the cleaning unit 12 is installed. The size and spacing of slits 8 on the discharge pipe 3 is determine to ensure that the discharged water for cleaning covers the complete surface area of the main solar panel 9. Also each slit 8 is not limited to individual slits but shall be plurality of holes.

The mini solar panel 4 is installed on the cleaning unit 12 for generate electrical energy for powering the water pump 1. The control unit 5 shall automatically control the functioning of the water pump 1. It shall control starting and ending of the operation of the water pump 1. The controls shall be either timer-based function or shall be operated by electronic wireless network controls via internet. The control shall also be with evaluation of loss in energy generated in main solar panels 9 in accordance with disclosed embodiment. In one embodiment of the invention, the control unit is enclosed in a watertight enclosure. The present invention uses wireless operation/control, that is by using ‘internet of things’ concept. Sensors can also be installed in the system to detect the accumulation of dirt in the solar panels and accordingly trigger the cleaning process.

Mechanical holding, system 6 shall be used to attach the solar cleaning system 100 on to the solar panel 9. It can be spring loaded clip or attached by means of bolts or through any other clamping fasteners without limitation to disclosed embodiments. The water filter unit 7 installed at the inlet end of the water intake pipe 2, filters and removes any particles that may be present in the water sucked through the water intake pipe 2. This will prevent any clogging of the water pump 1 or the discharge pipe 3. It also ensures that clear particle less water is discharged from the discharge pipe 3 for cleaning the imin solar panels 9.

The discharge pipe 3 is provided with slits 8 of various sizes along the length of the discharge pipe 3. The size or diameter of the slit 8 and the spacing of the slit 8 along the length of the discharge pipe 3 is determine so as to get a complete uniform distribution of the discharge water on the surface of the solar panel 9.

The present invention uses renewable energy itself for cleaning the solar panel using the same water on which the floating solar panels are installed. No additional energy source is required for cleaning the solar panels.

Solar cleaning system can be it taped on floating solar panels of various dimensions/sizes. Proposed design facilitates an easy installation on the solar panels eliminating expensive piping system typically installed for supplying water for cleaning of the panels.

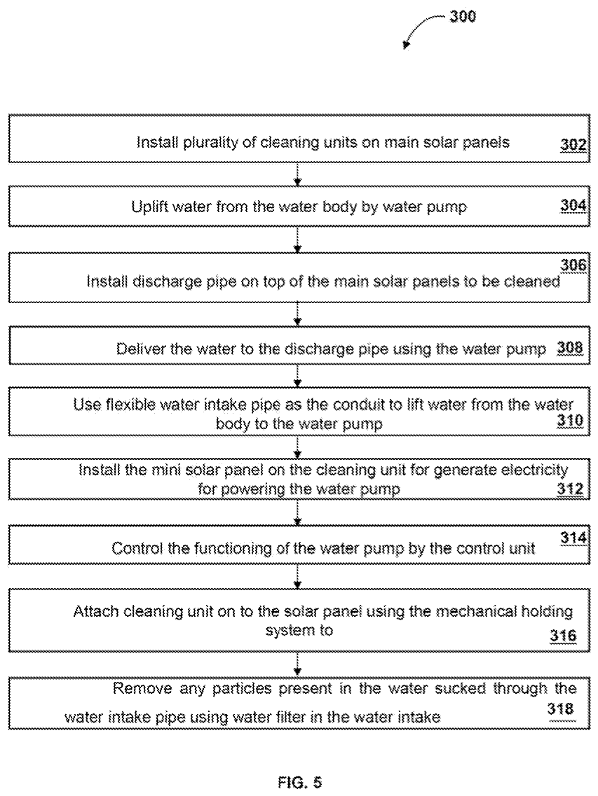

FIG. 5 shows an example flowchart pertaining to an example method 300 for cleaning least one solar array on a surface of a water body, in accordance with the present invention. The present invention is a unique concept of solar panel cleaning system 100 which can be easily installed on to the floating solar panels, which is otherwise very difficult to install on floating structure. As at step 302, a plurality of cleaning units is installed on the solar panels, then as at steps 304 and 306, using at least one water pump the water is uplifted from the water body and delivered to a discharge pipe. This water is used for cleaning the main solar panels.

As at step 308, a discharge pipe is installed on top of the solar panel to be cleaned and by using at least one flexible water intake pipe as a conduit, water from the water body is lifted using water pump, as at step 310, delivered to solar panels through discharge pipe. At least one mini solar panel in the cleaning unit is used to generate electrical energy for powering the water pump, as at step 312. As at step 314, the functioning of the water pump can be controlled using the control unit. Then, as at step 316, the mechanical holding system can be used to attach the cleaning unit on to the solar panel. The water filter in water intake pipe is used to remove any particles present in the water sucked through the water intake pipe, as at step 318.

Thus, the present invention provides a novel cleaning system that is operated by solar power itself and hence do not require any external power source. The cleaning system of present invention uses water from the water body where the floating solar panels are installed, hence do not require external water resources. Each main solar panel is installed with a totally independent cleaning system and hence do not require elaborate piping systems or water tanks as in conventional cleaning systems.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

I claim:

1. A system (100) far cleaning one or more main solar panels (9) installed on structures floating on a surface of a water body (11), the system (100) characterized in that comprising:
a plurality of cleaning units (12) installed on one or more main solar panels (9),
wherein each of the cleaning unit (12) comprises:
at least one water pump (1) capable of uplifting water from the water body (11) and deliver it to a discharge pipe (3);
at least one flexible water intake pipe (2) installed as a conduit to lift water from the water body (11) to the water pump (1) installed on a control unit (5), wherein the flexible water intake pipe (2) is installed along with a filter unit (7);
at least one mini solar panel (4) installed on the cleaning, unit (12) is used far generating electrical energy for powering, the water pump (1);
wherein the control unit (5) is used to control the functioning of the water pump (1);
at least one mechanical holding system (6) to attach the cleaning unit (12) on to the main solar panel (9); and
at least one water filter in the water intake pipe (7) to remove any particles present in the water sucked through the water intake pipe (2).

2. The system of claim 1, wherein the water used for cleaning of the main solar panels (9) is obtained from the water body (11).

3. The system of claim 1, wherein the solar energy generated from a mini solar panel (4) is used to power the cleaning unit.

4. The system of claim 1, wherein each of the cleaning unit (12) installed on the main solar panels (9) are independent of each other.

5. The system of claim 1, where each of the individual cleaning units (12) are operated separately, removed or replaced without effecting the function of cleaning unit installed on adjacent solar panels.

6. The system of claim 1, wherein the control unit (5) is operated as a timer-based function or operated using an automatic control or an electronic wireless network control.

7. The system of claim 1, wherein each of the individual cleaning units (12) are configured to be installed on the main solar panels (4) of various dimensions.

8. A method (300) cleaning the main solar panels (9) installed on structures floating on the surface of the water body (11) using the system (100) of claim 1, the method characterized in that comprising:
installing the plurality of cleaning units (12) on the twin solar panels (9);
uplifting, by the one water pump (1), the water from the water body (11);
installing a discharge pipe (3) on top of the main solar panels (9) to be cleaned;
delivering, by the water pump (1), the water to the discharge pipe (3);
using the flexible water intake pipe (2) as the conduit to lift water from the water body (11) to the water pump (1);
installing the mini solar panel (4) on the cleaning unit (12) for generate electrical energy for powering the water pump (1);
controlling, by the control unit (5), the functioning of the water pump (1);
attaching, by the mechanical holding system (6), to attach the cleaning unit on the solar panel (9);
removing, by the water filter in the water intake pipe (7), any particles present in the water sucked through the water intake pipe (2).

9. The method of claim 8, wherein the control unit (5) is operated as a timer-based function or operated using an automatic control or an electronic wireless network control.

10. The method of claim 8, wherein the water used cleaning of the main solar panels (9) is obtained from the water body (11).

11. The method of claim 8, wherein the generated solar energy is from a mini solar panel (4) is used to power the cleaning unit.

12. The method of claim 8, wherein installation of each of the cleaning unit (12) is configured to be on the main solar panels (9) and are independent of each other.

13. The method of claim 8, wherein each of the individual cleaning units (12) are operated separately, removed or replaced without effecting the function of cleaning unit installed on adjacent solar panels.

14. The method of claim 8, wherein the operation of the control unit (5) is timer-based function or operated using an automatic control or an electronic wireless network control.

15. The method of claim 8, wherein each of the individual cleaning traits (12) are configured to be installed on the main solar panels (4) of various dimensions.
